(19) United States
(12) Patent Application Publication
(10) Pub. No.: US 2010/0071505 A1
(43) Pub. Date: Mar. 25, 2010

(54) Coupling assembly between treadle and crank of bicycle

(75) Inventor: Wen-Hwa Lin, Taichung County (TW)

Correspondence Address: CHARLES E. BAXLEY, ESQUIRE, 90 JOHN STREET, SUITE 309, NEW YORK, NY, 10038, US

(73) Assignee: VP Component Co., Ltd.

(21) Appl. No.: 12/284,388

(22) Filed: Sep. 22, 2008

(51) Int. Cl. B62M 3/08

(52) U.S. Cl. 74/594.4

(57) ABSTRACT

A coupling assembly is provided between a treadle and a crank of a bicycle and comprises a connecting nut for being assembled to a threaded hole of a crank with a threaded segment thereof, and a treadle shaft combined with a treadle for being assembled to a threaded hole of the connecting nut with a threaded segment thereof.

### BACKGROUND OF THE INVENTION

1. Technical Field

The present invention relates to a coupling assembly between a treadle and a crank of a bicycle. The coupling assembly has a compact and simplified structure and is convenient to be assembled and disassembled so as to benefit bicycle manufacturers by reducing assembling time and allow a bicycle user to replace treadles by himself/herself easily.

2. Description of Related Art

A known approach for coupling a treadle with a crank of a bicycle, as can be seen in FIG. 1, comprises a treadle shaft 11 combined with the treadle 10 and a connector 21 combined with the crank 20. The treadle 10 is allowed to revolve on the treadle shaft 11 freely and the connector 21 has one end provided with a threaded segment 22 for being coupled with a threaded hole 23 formed on the crank 20. The connector 21 has an opposite end formed with a hole 24 for receiving the treadle shaft 11, wherein a wall defining the hole 24 is provided with a plurality of balls that are annularly arranged. The balls are controlled by a controlling ring 26 attached to an exterior of the connector 21 to move toward or away an axis of the connector 21. When moving toward the axis of the connector 21, each said ball 25 partially projects from the hole 24 and gets coupled with a corresponding ball recess 12 formed on the treadle shaft 11, so that the treadle shaft 11 is combined with the connector 21. When moving away the axis of the connector 21, each said ball 25 no more exposes in the hole 24 and leaves the corresponding ball recess 12, so that the treadle shaft 11 is free from the combination with the connector 21.

The conventional connector 21 composed of tiny springs, recesses, rings and other positioning elements is structurally complicated and difficult to be assembled. Nevertheless, a defective connector 21 can significantly increase time consumption of bicycle assembling process and raise failure rate of bicycle assembling process. Besides, once the treadle is coupled with the crank, the coupling problem between the controlling ring 26 and the balls 25 can render the treadle shaft 11 jammed in the connector 21 and the treadle 10 can be no more disassembled from the crank 20. In such a case, a bicycle user has no way to replace the treadle by himself/herself and it is inescapable to replace the connector 21 together with the treadle.

### SUMMARY OF THE INVENTION

The primary objective of the present invention is to provide a coupling assembly between a treadle and a crank of a bicycle, which coupling assembly has a compact structure and is convenient to be assembled and disassembled so as to benefit bicycle manufacturers by reducing assembling time and allow a bicycle user to replace treadles by himself/herself easily.

To achieve this and other objectives of the present invention, the disclosed coupling assembly comprises a connecting nut for being assembled to a threaded hole of a crank with a threaded segment thereof, and a treadle shaft combined with the treadle for being assembled to a threaded hole of the connecting nut with a threaded segment thereof.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 illustrates a conventional approach for coupling a treadle and a crank;

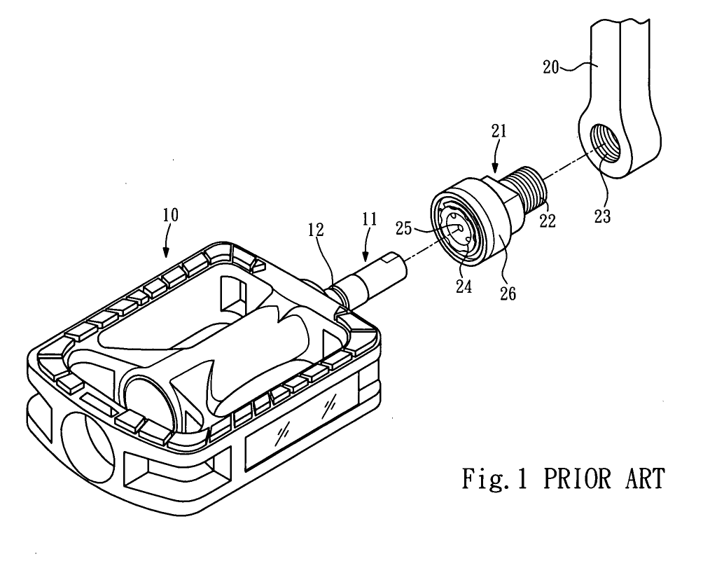

FIG. 2 is an exploded view of a coupling assembly of the present invention showing a treadle shaft of a treadle, a crank and a connecting nut therebetween;

FIG. 3 is a further exploded view of the coupling assembly of the present invention;

FIG. 4 is a perspective view of the treadle assembled to the crank through the coupling assemble of the present invention; and

FIG. 5 is a cross-sectional of the treadle assembled to the crank through the coupling assemble of the present invention; and

### DETAILED DESCRIPTION OF THE PREFERRED EMBODIMENTS

While a preferred embodiment is provided herein for illustrating the concept of the present invention as described above, it is to be understood that the components in these drawings are made for better explanation and need not to be made in scale. Moreover, in the following description, resemble components are indicated by the same numerals.

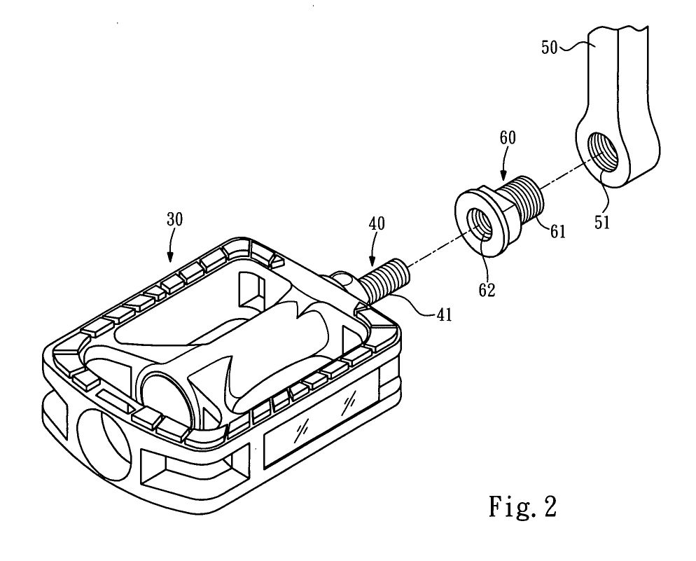

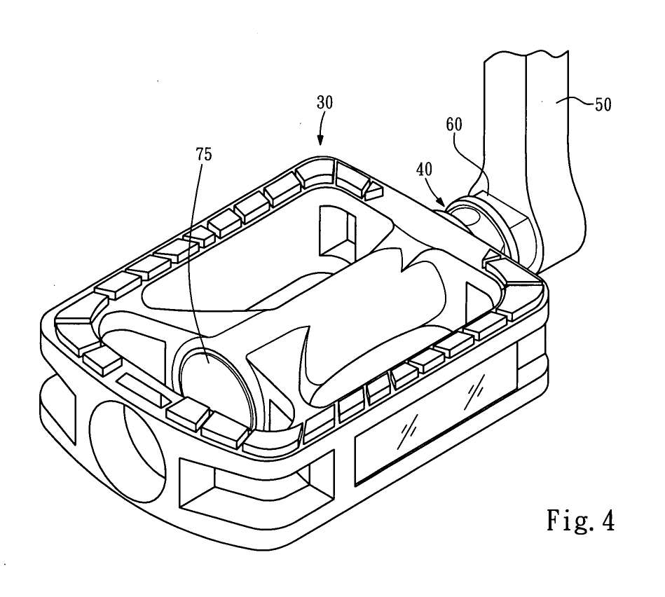

Referring to FIGS. 2, 4 and 5, a coupling assembly between a treadle 30 and a crank 50 of a bicycle comprises a treadle shaft 40 combined with the treadle 30 and a connecting nut 60 combined with the crank 50. The connecting nut 60 has one end thereof formed with a threaded segment 61 for being coupled with a threaded hole 51 of the crank 50. The connecting nut 60 further has a threaded hole 62 axially passing though two end thereof. The treadle shaft 40 has a part projecting from the treadle 30 formed as a first threaded segment 41 for being coupled with the threaded hole 62 of the connecting nut 60 so as to combine the treadle 30 with the crank 50.

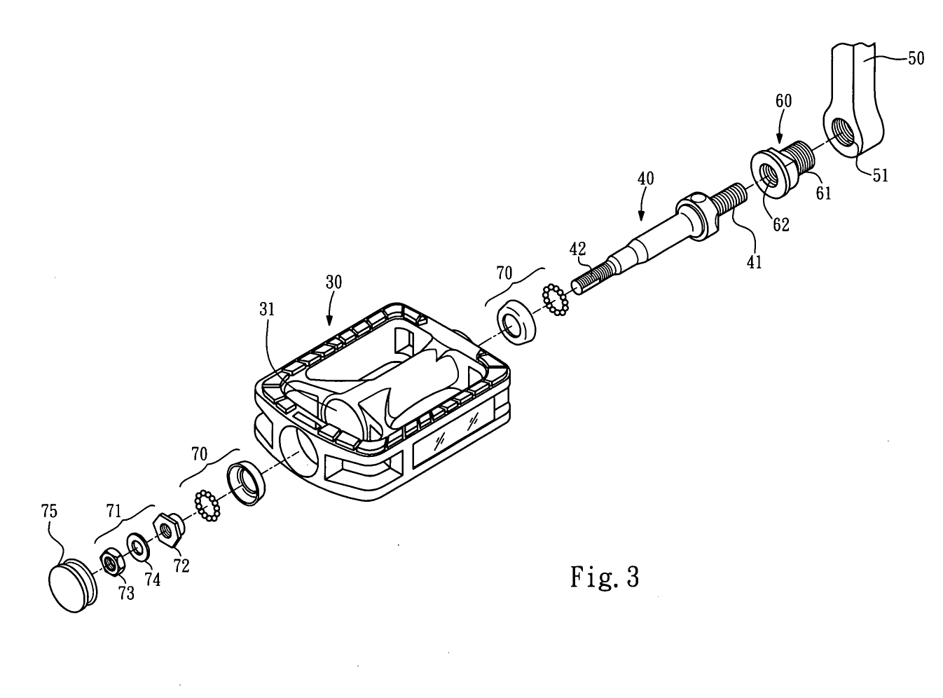

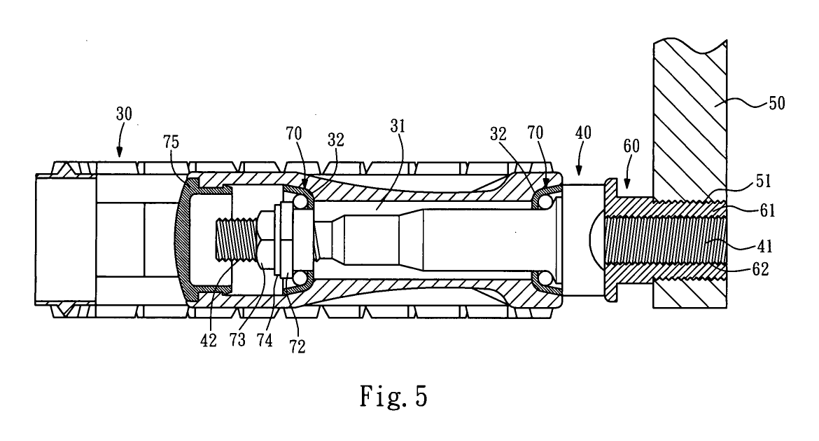

FIGS. 3 and 5 further illustrate the combination of the treadle shaft 40 and the treadle 30. The treadle shaft 40 is received in a shaft hole 31 formed in the treadle 30. Two rolling sets 70 are mounted around the treadle shaft 40 and a wall defining the shaft hole 31 is provided with two positioning elements 32 for fastening the two rolling sets 70 therein. One end of the treadle shaft 40 in the shaft hole 31 has a second threaded segment 42 coupled with a retaining set 71. According to the present embodiment, the retaining set 71 comprises two retaining nuts 72, 73 and a gasket 74 settled therebetween. A cap 75 is arranged at an opening end of the shaft hole 31 of the treadle 30. By the above structure, the treadle 30 and the treadle shaft 40 are combined in a manner that the treadle 30 revolves on the treadle shaft 40 freely.

While the connecting nut 60 and the treadle shaft 40 are coupled through threads, the combination of the crank 50 and the treadle 30 in structurally compact and simplified so as to simplify the assembling process of the treadle 30 and the crank 50. Moreover, since the crank 50 and the treadle 30 are coupled in such simplified manner, it is possible for a normal bicycle user to replace the treadle by himself/herself.

Furthermore, both the combination between the threaded segment 61 of the connecting nut 60 and the threaded hole 51 of the crank 50 and the combination between the first threaded segment 41 of the treadle shaft 40 and the threaded hole 62 of the connecting nut 60 can be realized by the known right-hand or left-hand threads as long as the treadle shaft 40 is secured from leaving the connecting nut 60 and the connecting nut 60 is secured from leaving the crank 50 while the treadle is treaded by a bicycle user

Although the particular embodiment of the invention has been described in detail for purposes of illustration, it will be understood by one of ordinary skill in the art that numerous variations will be possible to the disclosed embodiment without going outside the scope of the invention as disclosed in the claims.

What is claimed is:

1. A coupling assembly for being provided between a treadle and a crank of a bicycle, the coupling assembly comprising:
a treadle shaft, which is combined with the treadle and has one end thereof projecting form the treadle formed with a first threaded segment; and
a connecting nut, which has one end thereof formed with a threaded segment for being coupled with a threaded hole of the crank;
wherein the connecting nut has a threaded hole axially passing though two ends of the connecting nut and the first threaded segment of the treadle shaft is coupled with the threaded hole of the connecting nut.
